(19) United States
(12) Patent Application Publication
(10) Pub. No.: US 2013/0060362 A1
(43) Pub. Date: Mar. 7, 2013

(54) Predictive gaming

(71) Applicants: Kathleen Murphy, McLean, VA (US); William Sudow, McLean, VA (US)

(72) Inventors: Kathleen Murphy, McLean, VA (US); William Sudow, McLean, VA (US)

(21) Appl. No.: 13/199,582

(22) Filed: Sep. 3, 2011

(51) Int. Cl. G06F 19/00

(52) U.S. Cl. 700/93

(57) ABSTRACT

A predictive game, and its method of play, include an input device utilizable for other purposes than in the predictive game (such as a mobile touch screen device having Internet and texting, phone, and/or email capability) and for inputting predictions of individual events of a sporting contest substantially immediately before the event occurs, and application software for the input device. The input device is connectable to a remote host computer which tracks inputs into the device and ultimately whether or not the predictive inputs are correct. The application software may display screens relating to prediction of football plays during a live football game, the screens displayed before each football play is run, and includes at least “Run” and “Pass” touch boxes. Other touch boxes may be provided by pictorial representations of football players.

### BACKGROUND AND SUMMARY

Interest in sporting contests is high in many places throughout the world, particularly in the United States. Not only are there many fantasy leagues, but sports fans of all types, on call-in radio and television shows, in sports bars, at parties, and around the water cooler at work, love to debate the progress, management, personnel decisions, and strategy of sports teams.

To take advantage of the high interest in sports strategy, a number of games have been developed or proposed—such as shown in U.S. Pat. Nos. 4,019,737, 5,916,024, 6,287,199, 6,394,895, and 7334796—which have as at least one element thereof the prediction of events that occur in sporting contests. For example, the '199 patent provides an interactive, predictive game control system using a specialized controller and a specialized input device that allows a fan watching the live TV broadcast of a soccer match to predict when the first goal will be scored—the first player to score, the first player to be booked, the final score of the game, and other events, and to compare the predictions to the actual occurrences. The '737 patent uses a specialized game board system to allow a player viewing a TV broadcast of a football game to utilize the player's own play calling ability and to compare it to the actual plays run during the game. In the mid 1990s a game table with video screen was used in some sports bars that like the '737 patent allowed a player to predict a play that would be run and compare it to the actual play. These proposals and systems typically require very specialized equipment in order for the player to participate, and oftentimes are not very versatile.

The invention relates to predictive gaming that is very versatile yet typically does not require—at the player's location—specialized equipment. Rather, according to the invention, conventional devices on the market may be provided with simple software applications that allow the user to engage in predictive gaming for a wide variety of sports, and at a variety of levels of detail chosen by the player. While the invention has broader applicability, for simplicity's sake, the invention will be described with respect to a live football game. The player may be viewing or listening to the game in the stands, via television at home, via radio in a car, on a computer, or in many other manners.

According to one aspect of the invention, a predictive game is provided comprising the following elements: An input device utilizable for other purposes than in the predictive game and for inputting predictions of individual events of a sporting contest substantially immediately before the event occurs; and application software associated with the input device. The input device is connectable to a remote host computer which tracks inputs into the device and ultimately whether or not the predictive inputs are correct. The application software associated with the input device may be provided in the input device, in the host computer, “The Cloud,” or other accessible location.

Preferably the input device comprises a mobile touch screen device, and the software displays cascading screen options on the screen of the mobile touch screen device. The mobile touch screen device has Internet or intranet connectivity, and texting, phone, and/or email capabilities. Some of the screen options may be pictorial representations of sports participants, so that by touching a pictorial representation of sport participant a prediction may be initially made (and completed as by touching an “Enter” touch box) or completed.

The software may display screens relating to prediction of football plays during a live football game, the screens displayed substantially immediately before each football play is run. In that case, the touch boxes may be defined by pictorial representations of football players at various positions, or spaces between football player symbols. For other sports, other rough or detailed pictorial illustrations of participants for those sports may be provided.

The game may be in combination with the host computer which transfers correct prediction and scoring information back to the mobile touch screen device after the result that is the subject of the prediction is known.

According to another aspect of the invention there is provided a mobile touch screen device having application software associated therewith which displays a screen with touch boxes for at least “Run” and “Pass”. The software preferably is embedded or otherwise located in the mobile touch screen device. At some point representations of football players may define touch screen boxes for selecting what particular player will be intimately involved with a predicted play.

The software associated with the mobile touch screen input device also enables displays of other cascading screens depending upon whether the “Run” or “Pass” touch box is selected, including one or more screens with representations of football players defining touch screen input boxes, including displaying a football team formation on the touch screen.

According to yet another aspect of the invention there is provided a method of playing a predictive game associated with an actual sporting event with interruptions of play long enough to allow intelligent prediction, comprising: a) selecting a cascading level of options displayed on a screen, which options relate to predictions of the outcome of individual events in the sporting contest; and b) comparing the predictive selections made to the actual outcomes of the individual events.

The method is preferably practiced using a mobile touch screen device, and may further comprise c) transmitting scoring associated with the actual outcome of the individual events back to the player practicing a). The method may include displaying football formations on the screen, including formations with football player images, some of which images define touch screen boxes for inputting selections.

In the implementation of the method, a) may be further practiced to display a screen having at least “Run,” “Pass,” and “Enter” touch boxes, and to display other screens with more detailed option touch boxes depending upon whether the “Run” or “Pass” touch box is selected and then the “Enter” box touched. Also, a) may be further practiced to provide on some screens football team formations, in turn provided by pictorial representations of football players, at least some of the pictorial representations which define touch boxes (and typically where others of the pictorial representations of football players do not define touch boxes).

It is the primary object of the invention to provide a versatile desirable predictive gaming device, system, and method. This and other objects will become clear from the detailed description of the invention, and from the appended claims.

### BRIEF DESCRIPTION OF THE DRAWINGS

FIG. 1 is a schematic representation of one form a basic system according to the invention could take;

FIG. 2 is a schematic representation of an exemplary introductory selection screen on a mobile touch screen input device according to the invention;

FIGS. 3-10 are schematic representations of exemplary further cascading selection screens on a mobile touch screen input device according to the invention; and

FIG. 11 is a schematic representation of exemplary possible selection scenarios on a mobile touch screen input device if the “Defense” option in FIG. 3 is selected.

### DETAILED DESCRIPTION OF THE DRAWINGS

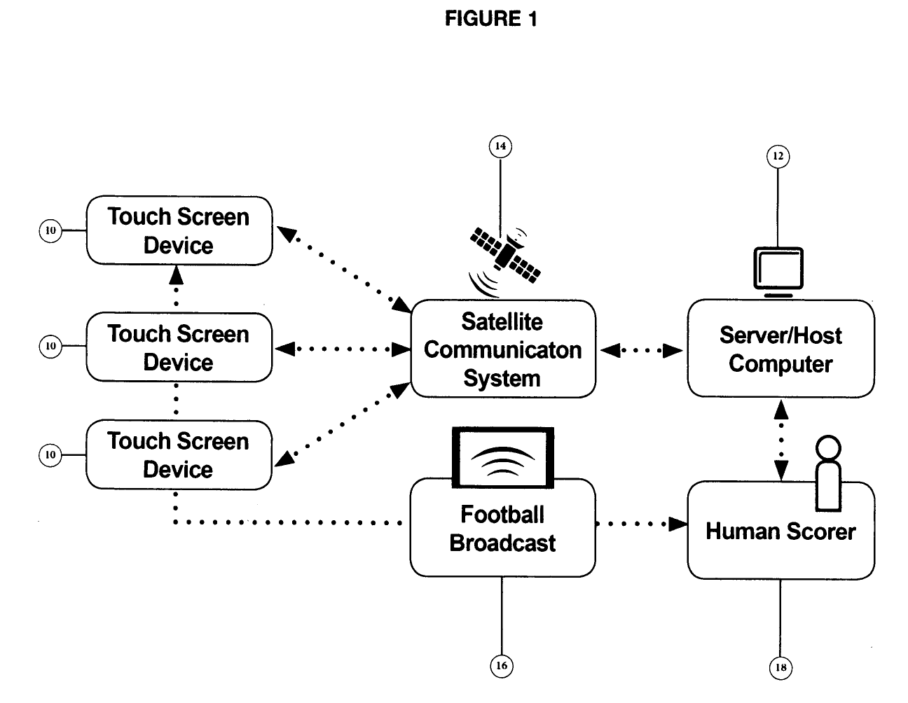

FIG. 1 is a schematic representation of a basic system according to the invention. A plurality of players, each with a commercial, otherwise conventional, touch screen device 10, communicate with a host computer 12 using any conventional communication link, such as the satellite system 14. Desirably, although not necessarily, the touch screen devices 10 are mobile touch screen devices. Non-limiting examples of mobile versions of the devices 10 are the following products which are commercially available at the time of filing of this document: iPhone, iTouch, iPad (any version), BlackBerry Storm, LuMaxArt, Samsung 1780, and any Android enabled device. That is, desirably, the mobile touch screen device 10 includes Internet or intranet connection, and texting, phone, and/or email capability.

Each touch screen device 10 has application software associated therewith which provides consecutive screens to be displayed having touch boxes which allow the player to easily input predictions. By “associated therewith” it is meant that the application software can be embedded or otherwise located in the device 10, is accessible by the device from the host computer 12 through the link 14, or is otherwise accessible by the device 10, such as a communication link with the Internet. The term “touch box” is used in its broadest sense, to mean any area of a screen which will input or assist in inputting a selection associated with the area, which area typically has alphanumeric or symbolic indicia associated therewith. The term “mobile” with respect to a device means that it can be readily hand held by the average human adult, as illustrated by the above examples.

The player inputs predictive information on the touch screen device 10 prior to the event being predicted actually taking place. In a live football game, the player would input the predictive information before each play was run (in a volleyball game or tennis match before each serve, in a baseball game before each pitch, etc.). The game is typically broadcast as schematically indicated at 16 in FIG. 1. The player may be sitting in the stands, viewing the game on the mobile device 16 if it has that capability, watching TV, or viewing a broadcast over the Internet on a computer while at home or in a bar, listening to a car radio, etc.

The predictive information input by the player into device 10 is transmitted via communication link 14 to the host computer 12, and assigned to that player's “account” in the host 12. Ultimately the data in that player's “account” can be compared by the computer to other player inputs, or maintained for scoring at a later date. Scoring data may then be communicated from the host 12 back through the communication link 14 to the device 10, or to another apparatus (such as a home computer) substantially immediately after each event predicted, or at some later time or date (e.g. after review of videotape on equipment that has slow motion and freeze frame capabilities, and many different camera angles). The touch screen of the mobile device 10 may also indicate, such as by a countdown, how long until the play must be predicted before the ability to predict is “locked out”.

While in the simplest form of the invention there is no immediate feedback to the player, in its most desirable form, according to the invention feedback is provided substantially immediately after the result of the prediction is known. To this end, a knowledgeable (e.g. ex-coach) human scorer (or team of scorers) 18 input the correct result of a predicted event substantially immediately after he/she/they view it (perhaps delaying to see what effect a penalty flag, or coaches' challenge, has on the outcome first) into the host 12. The host 12 then compares the correct result to the predictions of all of the players using their devices 10, and the players' scores, and/or the correct result, are substantially immediately transmitted by the computer 12 through the link 14 back to the individual devices 10, typically before it is necessary for the player to input the next prediction. The scores may be just for a single recent play, cumulative for the entire game to that point, or both. The host 12 may retain scores for each player for an entire season, or even longer.

Instead of scorers working each game, conventional sports data providers, such as at http://www.stats.com/realtime.asp, may be utilized to do the scoring, which could then be done automatically, or semi-automatically. The screens provided by the applications software for predictions would be designed to correspond to the data provided by the commercial data provider used.

As a simplistic example of how a predictive game might be played, according to the invention, the following scenarios might play out, with corresponding screens displayed on the device 10 for a player to make the player's predictions.

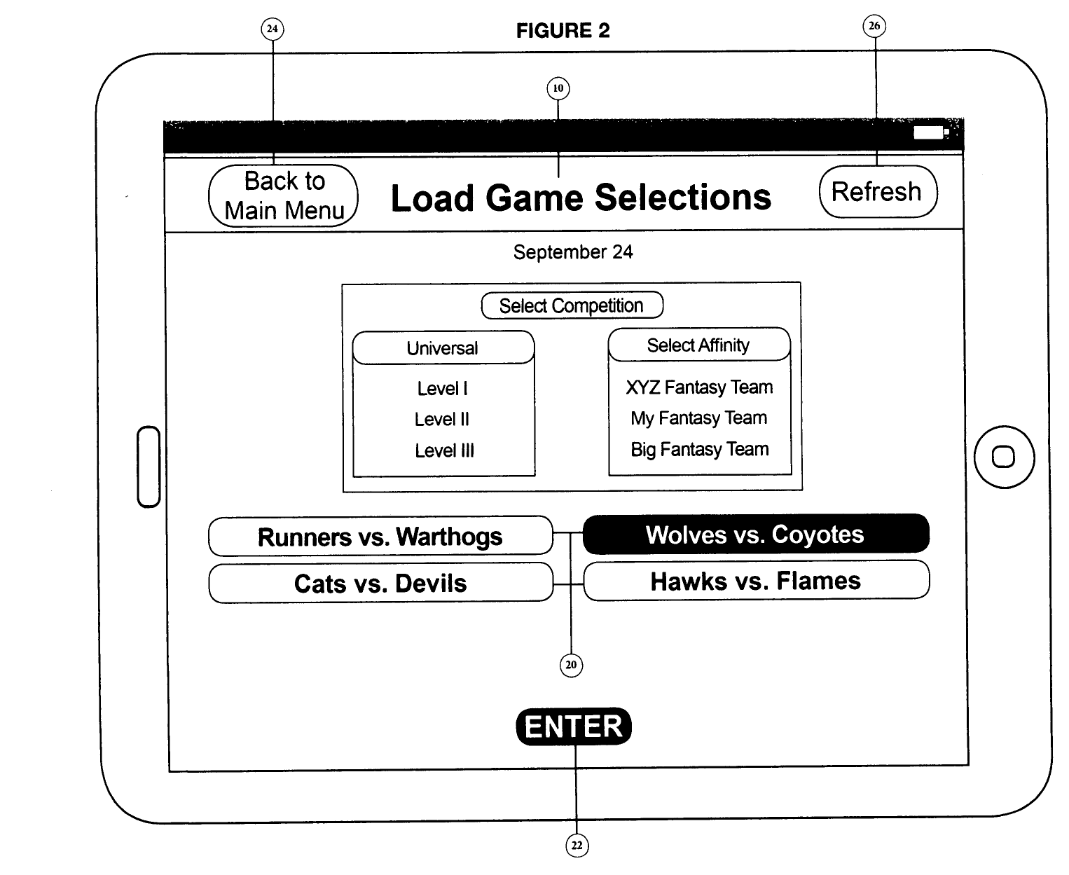

As seen in FIG. 2, the first selection screen may ask the player which game he/she wants to interact with. For example there may be four touch boxes 20 displayed on the screen of device 10, Team A vs. Team B (Wolves vs. Coyotes in the representative example in FIG. 2), C vs. D, E vs. F, or G vs. H. The player touches the A vs. B box 20 on the screen of device 10. [A screen may also be provided asking the player to predict which team will win, and by how much, and/or what the score will be]. Then the player touches the “Enter” box 22.

Alternatively, the player could touch the “Back to Main Menu” box 24, or “Refresh” box 26 at any time to return to a previous menu selection, or to refresh the screen displayed.

FIG. 2 also illustrates an option whereby the level or type of competition which the user will be playing against may be selected by touching a particular touch box. Under the “Select Competition” illustration in FIG. 2 there are two options, a “Universal” option and an affinity group option (“Select Affinity”). Under the “Universal” option by touching the appropriate touch box one would play against the entire universe of subscribers to a certain Internet and/or phone provider, or users of the application for a particular device (e.g. iPad technology owners, A T & T subscribers, etc.). The touch boxes with indicia with different levels (“Level I”, etc.) illustrated in FIG. 2 could be different universes of players/subscribers/users.

Under the “Select Affinity” option in FIG. 2, various touch boxes are provided allowing one to select a number of different closed and/or small groups. For example one touch box could be for an existing fantasy league the user is a participant in, another touch box with the IPO addresses of the individuals with which the user is watching a football game on TV, etc. The scoring displays subsequently described (52, 54) would then display the scores for the individual user (52) and the best score in the particular small group (54) the user had selected by touching the appropriate touch box in FIG. 2.

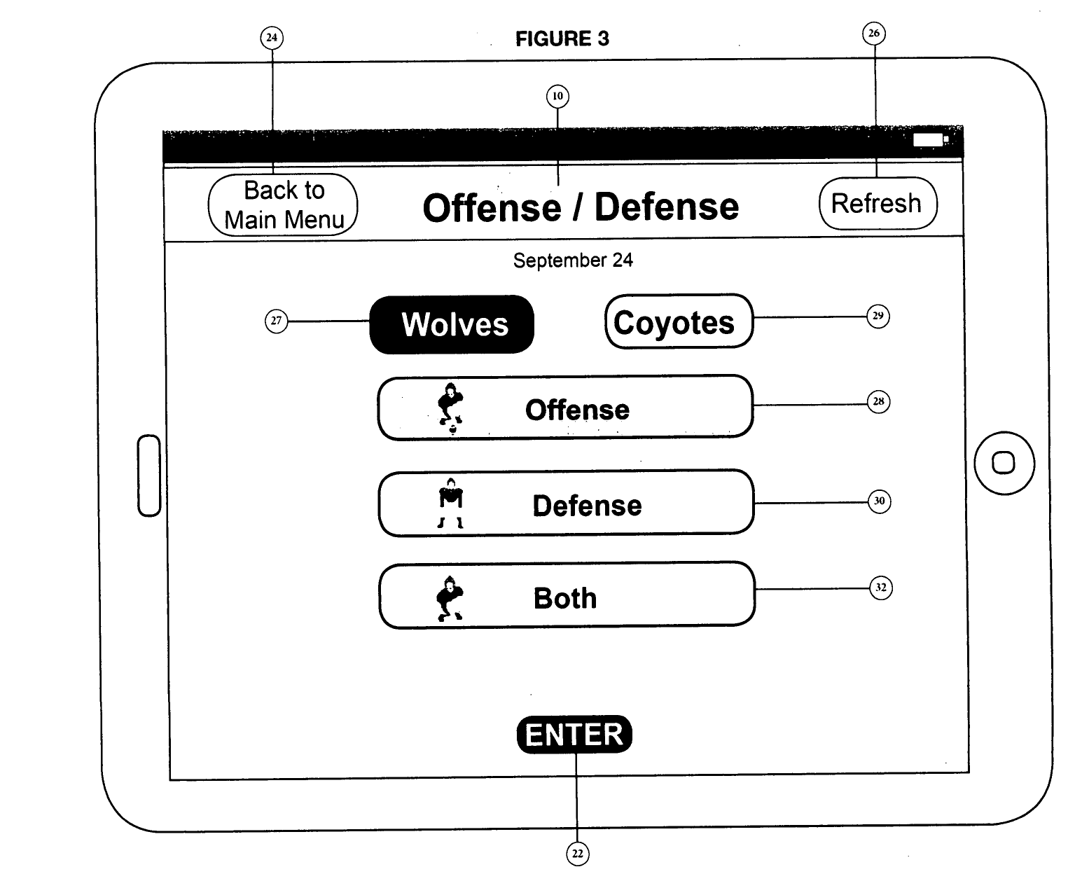

The second selection screen of device 10 is schematically illustrated in FIG. 3. This screen may—as illustrated—ask the player whether she/he wants to predict only offensive plays (touch box 28), only defensive plays (30), or both (32). The player touches the “Offense Only” box. The player may select “Offense Only” for Team A, touch box 27 in FIG. 3, and not try to predict what Team B will do, or may select “Offense” when Team A has the ball, and “Defense” when Team B has the ball, or select “Offense” for both Teams A & B (in each case touching box 27 or 29 first, then box 28).

Preferably all screens have the touch boxes 22, 24 and 26.

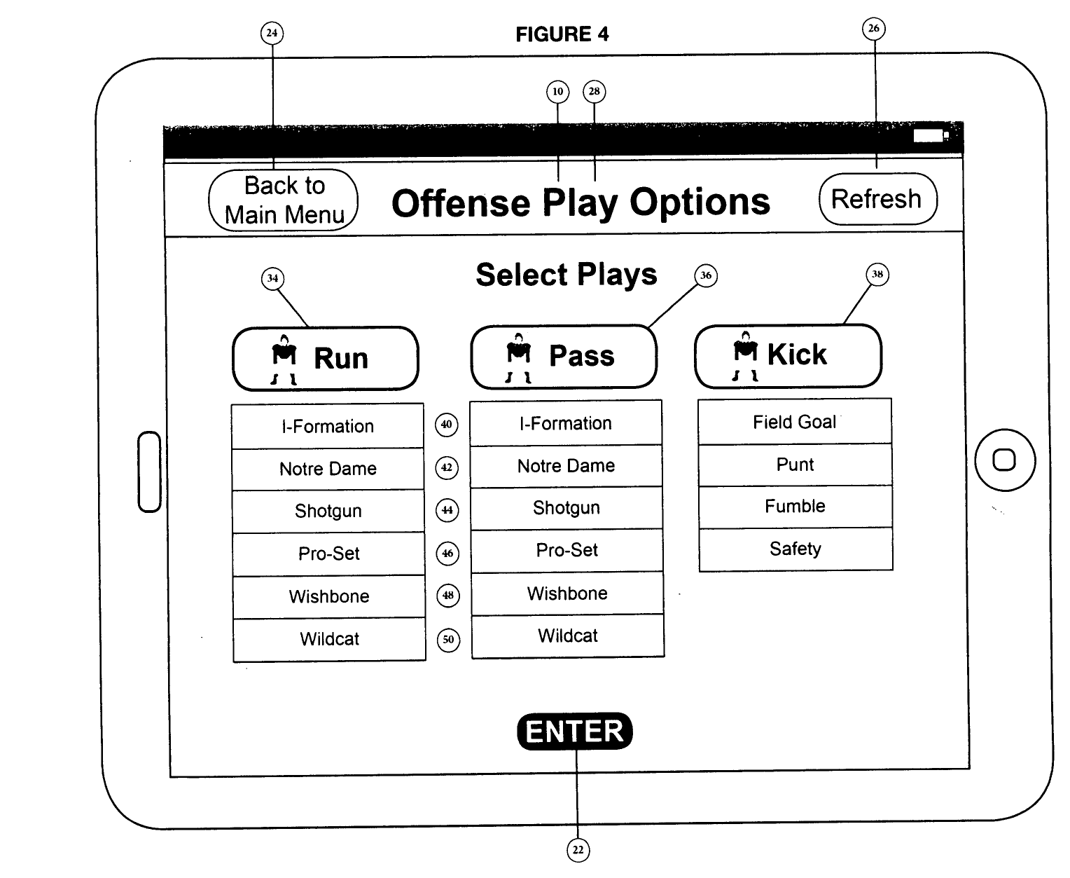

The prediction screens that follow may have any level of detail desired, and the levels may cascade—that is, upon the selection of one level, multiple other more detailed options are displayed in other screens. For example, the exemplary third selection screen of FIG. 4 may ask the player to predict “Run” (touch box 34), “Pass” (36), “Kick” (38), or even “Penalty” (not shown). Also on the screen of FIG. 4 are various formation touch boxes 40, 42, 44, 46, 48, and 50 under the “Run” and “Pass” categories, as well as other touch boxes (not numbered in FIG. 4) associated with the “Kick” touch box 38.

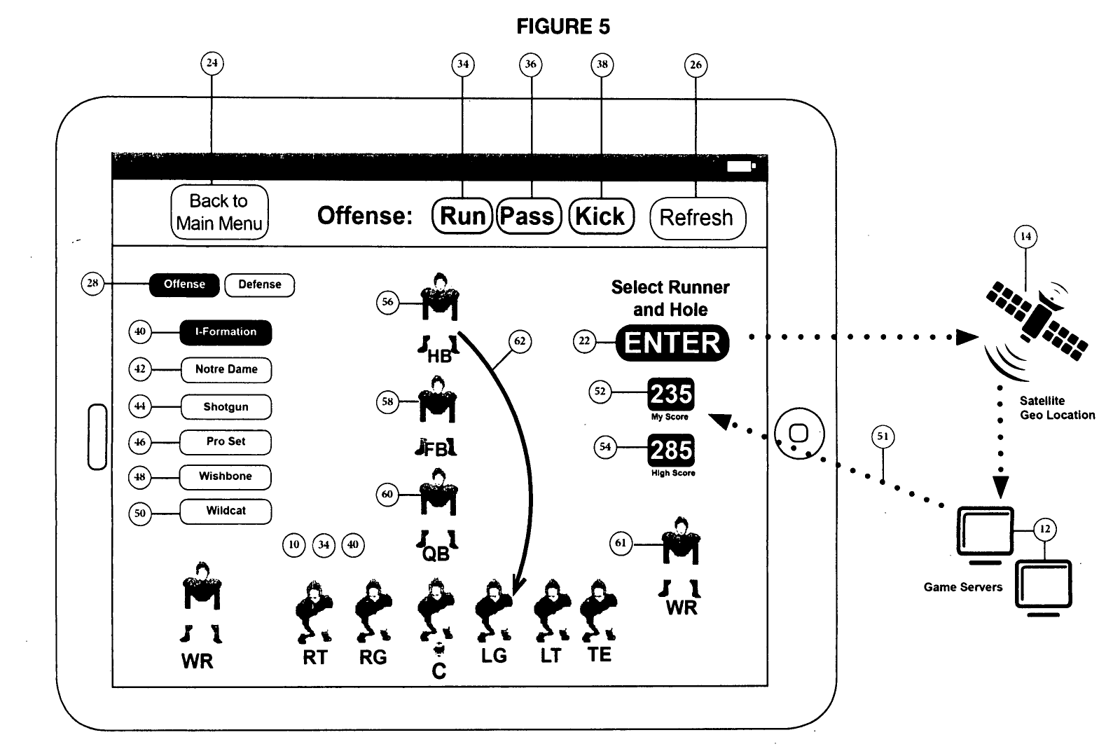

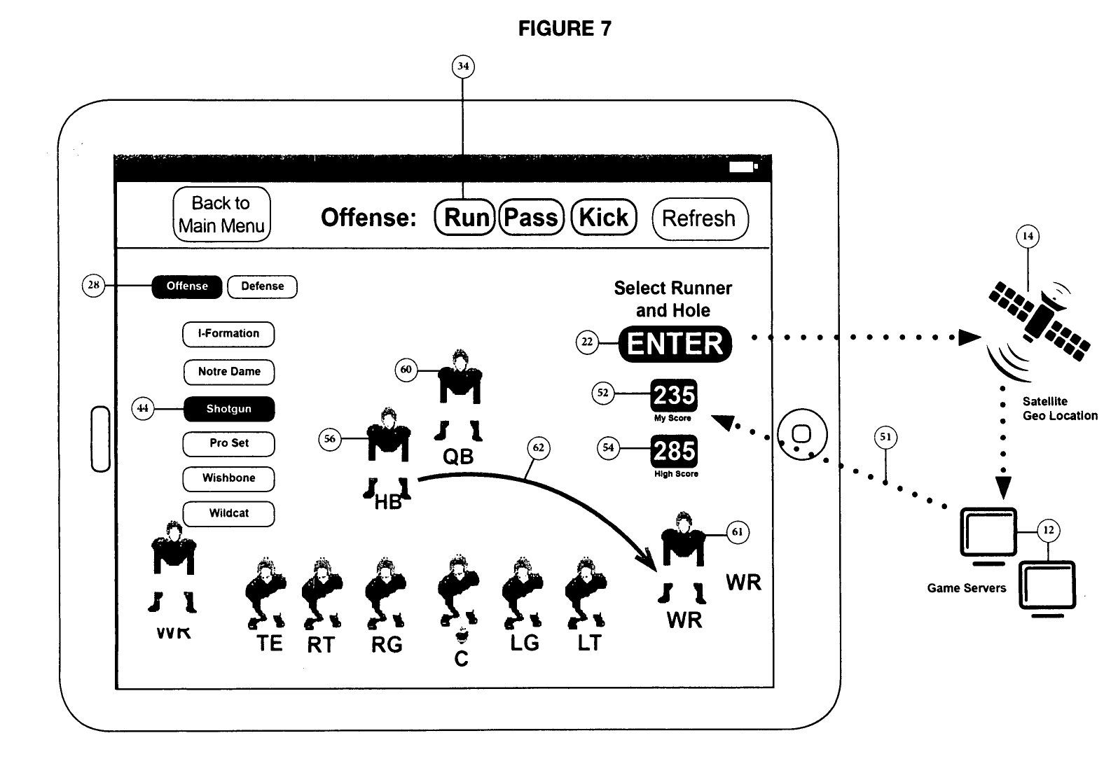

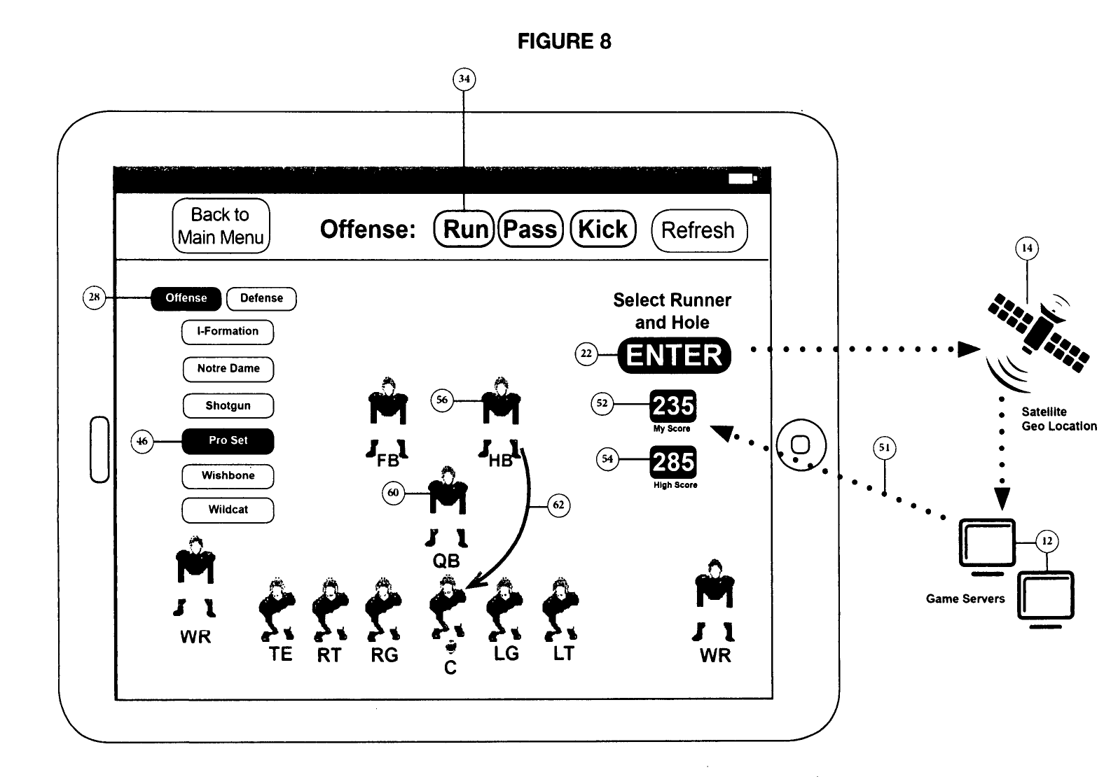

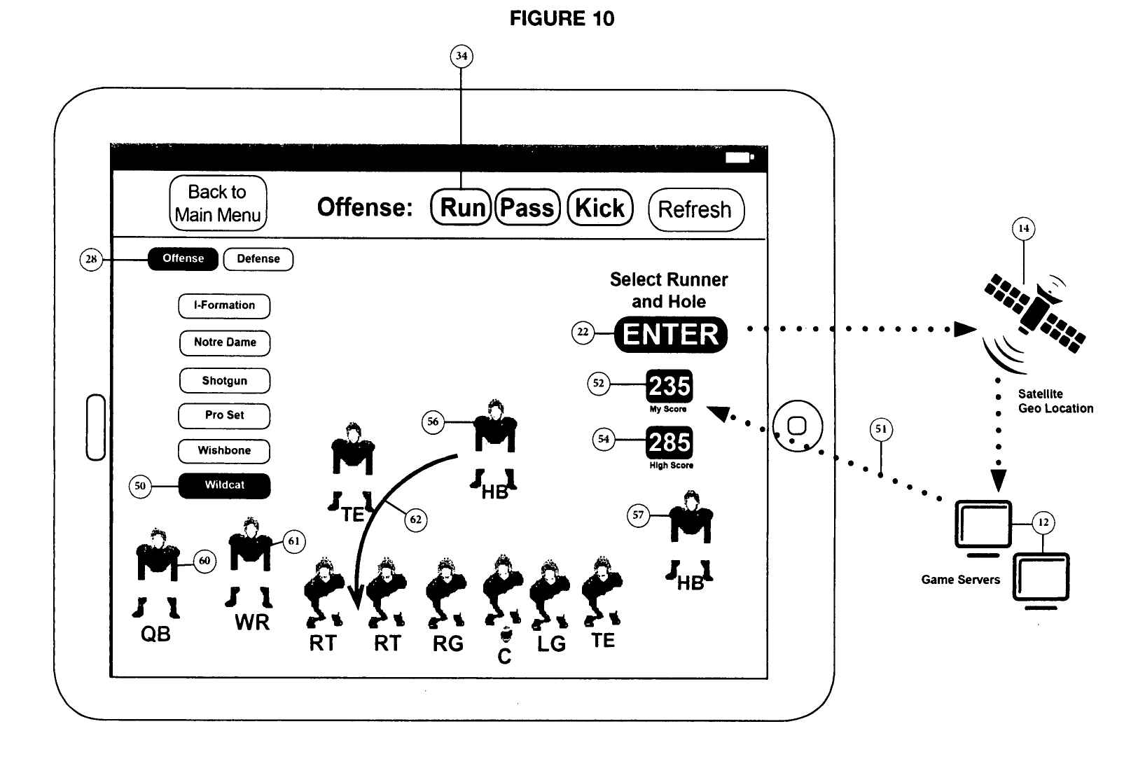

Since the possible options are virtually endless just for one sport (such as football), let alone considering other sports (such as tennis, baseball, and golf), just one exemplary scenario will be described further in and with respect to the drawings. For all of the selection screens of FIGS. 5-10 the “Run” touch box 34 in FIG. 4 will have been selected, as well as a different box 40-50 for each of the FIGS. 5-10.

To get to the screen of FIG. 5, the user of the mobile touch screen device 10 touched box 34 in FIG. 4, then box 42 (“I-Formation”), then box 22. A representation of an I-formation appears, as illustrated in FIG. 5. It is desirable, though not necessary, if scoring is substantially immediately provided from host 12 (e.g. as input by some sports service or human scorer) through communication 51, to display the player's present score in a display area 52, and possibly the high score for all players presently participating in a display area 54.

While FIGS. 5-10 illustrate the players in the various formations by pictorial illustrations of football players with equipment on, such as in FIG. 5 the halfback 56, fullback 58, quarterback 60, and wide receiver 61, instead simple geometric shapes (such as squares, ovals, triangles, circles, etc.), or other indicia or symbols, may be provided. At least each of the representations 56, 58, 60 and 61 in FIG. 5 is an active, activatable, touch box, and preferably other pictorial representations are not.

Any level of sophistication of selection may be provided. For example no specific selection, just “Run,” or “Run” and the formation, may be selected. Or additionally the person who will carry the ball can be touched (e.g. HB 56 in FIG. 5), or the location where the runner will attempt to run may also be selected (e.g. by the user dragging her/his finger over the screen of device 10 to the hole, as indicated by path and arrow 62 in FIG. 5, or by the spaces between offensive linemen providing touch boxes for hole selection). Obviously, the more detailed the selection, the more potential points are available.

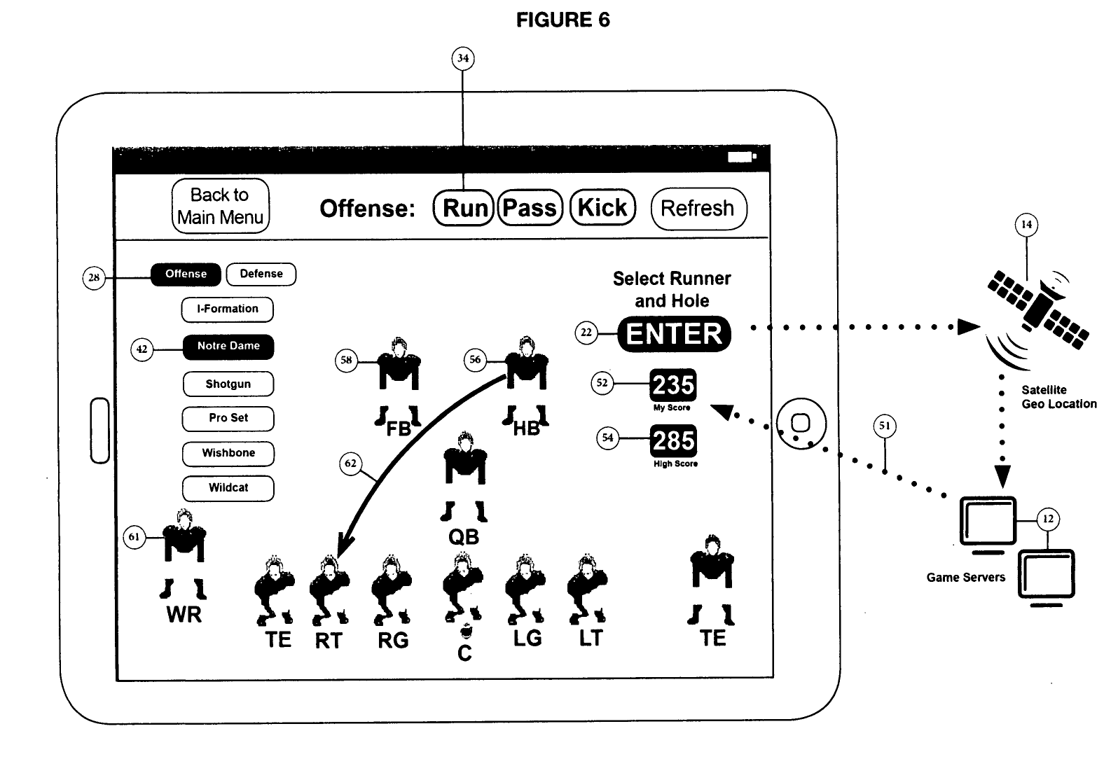

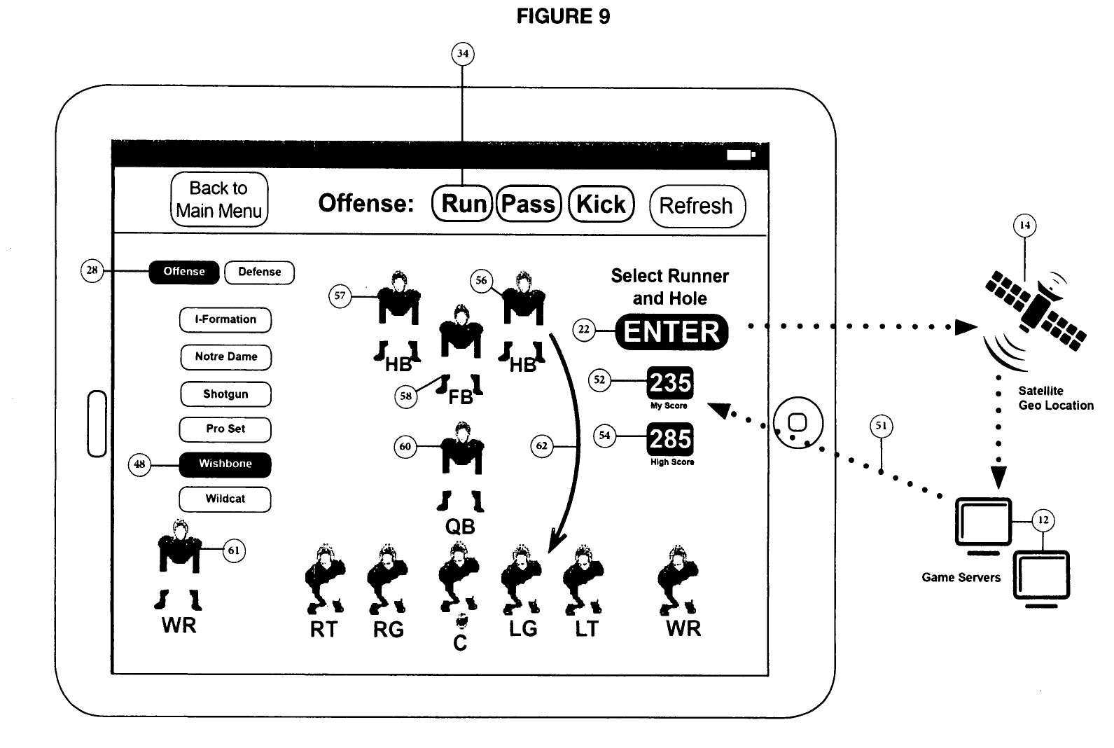

FIGS. 6-10 show screens similar to the screen of FIG. 5 only for each of the other formations in boxes 42, 44, 46, 48, and 50. In some screens more, or other, symbolic representations of football players may be touch boxes—for example the additional halfback 57 in the Wishbone formation of FIG. 9.

Screens similar to those of FIGS. 5-10 may be provided when the “Pass” option (36 in FIG. 4) is selected, only in that case the touch box associated with the eligible receiver who catches the ball (or simply has the ball thrown to him) is touched, and dragged to the general area of the field where the pass will be thrown (left, middle right, roughly ⅓ of the screen area each). Other modifications may be provided too.

As an alternative, the “Pass” screen associated with a given formation may have touch boxes for “Long”, “Flair”, “Screen” or “Short” passes, which also will have predetermined meanings pursuant to the rules of the game. [For example “Long” means the ball travels ten yards or more before it is touched by a receiver, “Short” less than ten yards; “Screen” means the receiver is behind the line with at least one near blocker in front when he touches the ball; “Flair” means that a back receives the ball without near blockers to one side of the field or the other.] There may also be a screen, or touch box, for whether the pass is complete or incomplete, if the quarterback is sacked or scrambles, if the pass is intercepted, if there is a fumble, if a touchdown is scored, etc., providing all probable or possible outcomes.

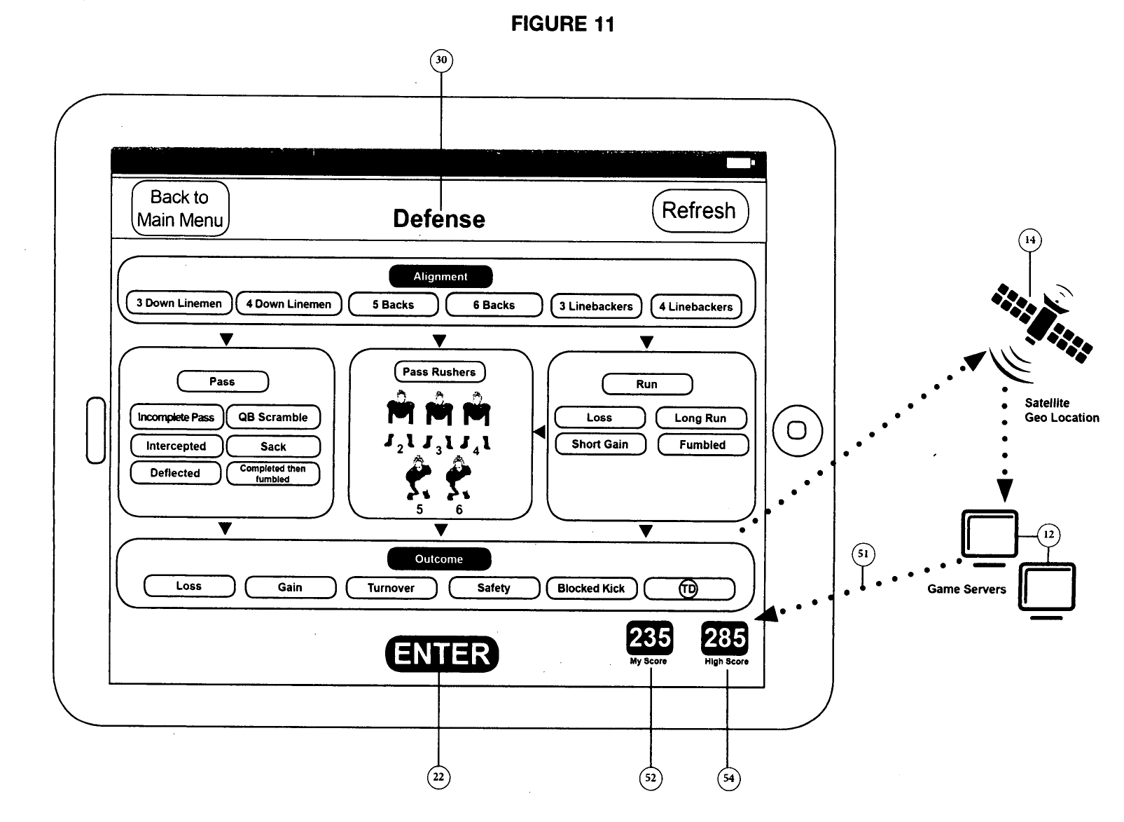

FIG. 11 is a schematic non-limiting matrix drawing showing possibilities for defensive predictions, which are self-explanatory in FIG. 11 (as after the box 30 in FIG. 3 is touched). As with the “Offense” screens, there would be an “Enter” touch box for each defensive screen. Also, the software associated with the touch devices 10 would provide that for certain screens more than one option may be selected, while for other screens only one could be. For example for the “Defense” screens of FIG. 11, on the “Alignment” screen one could touch both the “5 backs” and “3 linebackers” touch boxes, but on the “Pass rushers” screen one could touch only one of 2, 3, 4, 5, and 6.

Scoring may be by any technique desired. Each player who is willing to take more risks and predict plays in more detail will be rewarded if correct, but may be penalized if incorrect. As a completely non-limiting example, provided just for demonstration purposes, if a player correctly predicts “Run” or “Pass” the player gets three points. If there is a “Kick” or the play is dead for any reason (e.g. penalty) the player will get zero, but if “Run” or “Pass” is incorrectly predicted the player will get minus one point. If “Kick” is correctly predicted on anything but 4^{th} down is correctly predicted, the player will get six points, but no negative points if there is no kick. If “Kick” is correctly selected on 4^{th} down, the player would only get one point, and minus one if incorrect. If the player is willing to not just select “Run”, but also selects the player to carry the ball and that is correct, the player gets an additional three points; if incorrect, the player gets minus one (but still gets the three points for correctly predicting a run), and gets yet another three points if the correct hole to run in is selected (but minus one if incorrect). Similarly for each of the further cascading screen options associated with “Run”.

Many other scoring options are possible. For example, if one wants to set up the game just based upon what is called by a team, rather than the actual result of the play, scoring would be on that basis. In this scenario, for example if was clear that a pass play was called but the quarterback was sacked, or if an offensive lineman was called for holding, the player would still get the points is he/she correctly selected “Pass” and would not be penalized for selecting a particular receiver, or pass depth, or area of the field. Points would usually not be awarded for more detailed calls for at least quarterback sacks or scrambles since it would be difficult to determine where the pass was going. However if it was clear to the human scorer 18 that a screen pass to a running back was called but resulted in a scramble, points could still be awarded to a player who correctly selected “Screen”.

Players may participate in groups, whose scores are kept by the host 12 just like is conventionally done now for on-line fantasy football and baseball leagues, or on-line for the NCAA college basketball tournament. Players leading their groups after a certain number of games may be eligible to compete in a “playoff”, with the winner or winners receiving prizes.

While the invention has been described specifically with respect to mobile touch screen devices and football because those are presently considered to be the most functional and desirable, in its broadest concepts the invention can be practiced using other input devices have additional functions than just playing this game, and for other sports. For example a mouse and computer screen may provide the input device, or another device which has functions that are not specific to use in the predictive game (such as use as a telephone, television, or word processor). Also, a game may be watched on a TV with a split screen, with one part of the TV screen showing the actual sporting contest, and another part displaying the predictive game options, which could be selected with a remote control which highlighted portions of the predictive game options part of the TV split screen.

Baseball, volleyball, tennis, ski jumping, golf, cricket, or other sports aside from football but with interruptions of play long enough to allow intelligent prediction, may be accommodated. For example in volleyball screens would ask the player to predict which team will score a point on a serve, whether the point will be scored by ace, block, error, kill, etc., and/or which participant is most responsible for scoring the point.

The invention is to be accorded the broadest interpretation possible consistent with the prior art, to encompass all equivalent structures and methods.

1. A predictive game comprising: an input device utilizable for other purposes than in the predictive game and for inputting predictions of individual events of a sporting contest substantially immediately before the event occurs; and application software associated with the input device; said input device connectable to a remote host computer which tracks inputs into the device and ultimately whether or not the predictive inputs are correct.

2. A game as recited in claim 1 wherein the input device comprises a mobile touch screen device, and wherein the application software displays cascading screen options on the screen of the mobile touch screen device.

3. A game as recited in claim 2 wherein the software displays screens relating to prediction of football plays during a live football game, the screens displayed substantially immediately before each football play is run.

4. A game as recited in claim 2 in combination with the host computer which transfers correct prediction and scoring information back to the mobile touch screen device after the result that is the subject of the prediction is known.

5. A game as recited in claim 1 wherein the input device includes a touch screen, and wherein said touch screen includes some touch boxes defined by pictorial representations of sports participants, or spaces between pictorial representations of sports participants.

6. A game as recited in claim 5 wherein the sports participants illustrated are football players.

7. A game as recited in claim 2 wherein said touch screen includes some touch boxes defined by pictorial representations of sports participants, or spaces between pictorial representations of sports participants.

8. A game as recited in claim 7 wherein the sports participants illustrated are football players.

9. A game as recited in claim 2 wherein the mobile touch screen device includes Internet or intranet connection, and texting, phone, and/or email capability.

10. A mobile touch screen device having application software associated therewith which displays a screen with touch boxes and having the indicia “Run” and “Pass” labeling at least some of the touch boxes.

11. A device as recited in claim 10 which displays other cascading screens depending upon whether the “Run” or “Pass” touch box is selected, and wherein at least some of the screens include a touch box labeled with the indicia “Enter” which must be touched before another selection is actually finally input.

12. A device as recited in claim 10 which displays indicia in the form of a football team formation on the touch screen.

13. A device as recited in claim 12 wherein the football team formation indicia is provided by pictorial representations of football players, and wherein at least some of said pictorial representations define touch boxes.

14. A device as recited in claim 13 wherein some of the pictorial representations of football players are not touch boxes, and wherein the application software is embedded in the device.

15. A method of playing a predictive game associated with an actual sporting event with interruptions of play long enough to allow intelligent prediction, utilizing a display screen from which options may be selected, comprising: a) selecting a cascading level of options displayed on the screen, which options relate to predictions of the outcome of individual events in the sporting contest; and b) comparing the predictive selections made to the actual outcomes of the individual events.

16. A method as recited in claim 15 wherein a) is practiced using a mobile touch screen device.

17. A method as recited in claim 16 further comprising c) transmitting scoring associated with the actual outcome of the individual events back to the player practicing a), and displaying score information on the screen.

18. A method as recited in claim 16 wherein a) is practiced to display a screen having touch boxes labeled with at least the indicia “Run,” “Pass,” and “Enter”, and to display other screens with more detailed option touch boxes depending upon whether the touch box labeled “Run” or “Pass” is selected and then the “Enter” box touched.

19. A method as recited in claim 18 wherein a) is further practiced to provide on some screens football team formations, in turn provided by pictorial representations of football players, at least some of said pictorial representations defining touch boxes.

20. A method as recited in claim 19 wherein a) is further practiced so that some of the pictorial representations of football players do not define touch boxes.
